(19) United States
(12) Patent Application Publication
(10) Pub. No.: US 2006/0250379 A1
(43) Pub. Date: Nov. 9, 2006

(54) Rounded tip of a pen for writing or typing on screens or keyboard

(76) Inventor: Luca Freudiger, Agno (CH)

Correspondence Address: YOUNG & THOMPSON, 745 SOUTH 23RD STREET, 2ND FLOOR, ARLINGTON, VA, 22202, US

(21) Appl. No.: 10/559,941

(22) PCT Filed: May 27, 2004
(86) PCT No.: PCT/IB04/01853

§ 371 Date: Dec. 8, 2005

(30) Foreign Application Priority Data
Jun. 13, 2003 (CH) 2003103203
Oct. 6, 2003 (CH) 0169303

(51) Int. Cl. G09G 5/00

(52) U.S. Cl. 345/179

(57) ABSTRACT

A pen (1) suitable for writing and/or typing on screens and/or keyboards of electronic equipment such as computers, personal organizers, palmtops, telephones or the like is described, said pen comprising an elongated stem (2) provided at at least one end (2e) with a coaxial cavity (3) able to house and retain inside it a rounded tip (4). In the pen (1) in question this tip (4) is made of a material chosen from a group comprising synthetic or natural hard stones and ceramic materials.

The present invention relates to the technological sector of accessories for electronic equipment such as computers, telephones, etc.

More particularly, it relates to the sector which deals with the manufacture of pens suitable for writing or typing on screens and/or keyboards of electronic equipment such as computers, personal organizers, palmtops, telephones and the like.

As is known, these pens consist of an elongated stem which is able to be gripped—like that of a normal pen used for writing—and is provided with a coaxial cavity designed and made so as to house inside it a rounded tip which emerges partially from it so as to be able to perform its functions described above.

According to the present state of the art, these tips are made of one of various synthetic resins known for applications of this kind.

These resins, in addition to being prone to abrasion, have a roughness and/or a porosity which, although of a limited nature, result in the absorption of small foreign bodies such as fine particles, dust, etc. which, clinging to the surface of the tip, alter the shape of the point of contact between the tip and the object over which it must pass in order to perform its functions.

This results, among other things, in a smaller degree of precision when drawings lines on screens and the like, in addition to wear of the said screens which with time may adversely affect operation thereof.

The inventor of the subject of the present invention has had the idea that all the abovementioned drawbacks could be overcome by replacing the materials used hitherto for the manufacture of the abovementioned tips with other materials which have a much greater abrasion resistance and are devoid of roughness and porosity. He has therefore selected a group of materials which are today used for applications which are totally different owing to their relatively high cost, with the idea that, in view of the small volume of a tip, the increased cost due to use of the said materials is amply offset by the far greater working life of the pen and by the absence of the abovementioned drawbacks associated with the formation of incrustations and the like which may damage the electronic equipment on which a pen is used.

The materials chosen by the inventor for manufacture of a pen tip according to the invention are: hard natural synthetic or—preferably, for costs reasons—monocrystalline stones such as ruby and sapphire, and ceramic materials, generally known as “technical ceramics”. All the abovementioned materials have in common the surface hardness characteristics necessary for obtaining the advantages described above, and, by means of grinding, smoothing, brushing or other operations of the known type, an exceptionally high surface finish is obtained, without a significant degree of roughness or porosity.

The subject of the present invention therefore consists of a pen suitable for writing and/or typing as described in the accompanying claim 1.

A preferred example of embodiment of the pen according to the invention will now be described, with reference also to the accompanying drawings, in which:

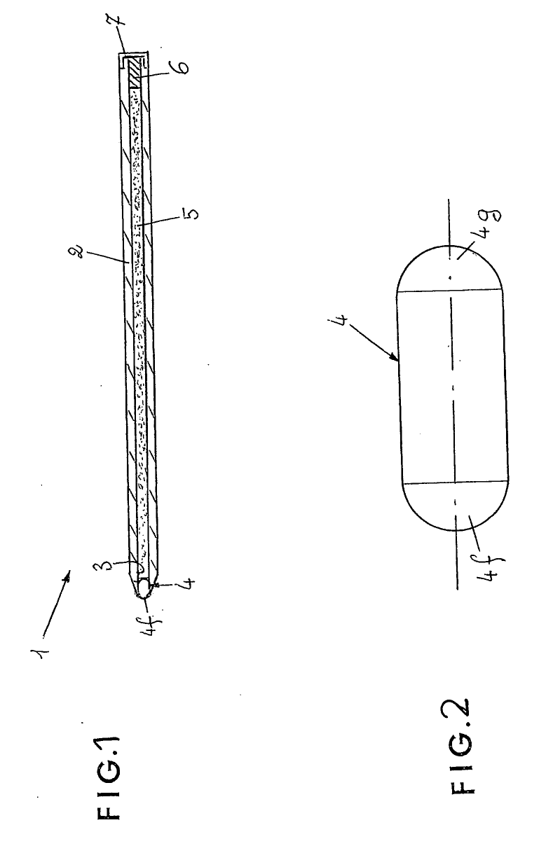

FIG. 1 is a longitudinal cross-sectional view, on a large scale, of the said example of embodiment of the pen according to the invention, which shows the position of the tip;

FIG. 2 is a side view, on an even larger scale, of the pen tip alone according to FIG. 1.

If we consider FIG. 1, in said figure it can be seen how a pen 1 according to the invention comprises, as do moreover similar pens of the known type, an elongated stem 2 provided with a coaxial cavity 3 able to house a rounded tip 4, retaining it internally.

The said cavity 3 in FIG. 1 extends over the whole length of the stem 2, but could also have a smaller length, i.e. limited to the sole end portion of the stem housing the tip 4.

The above cavity 3 in the case in question is a cylindrical shaped seat which is tapered outwards in the region of the tip 4 so as to retain the latter, allowing only one end 4f thereof to project outwards.

In the case considered here, the tip 4, which is illustrated more clearly in FIG. 2, has the shape of a cylinder with its two ends 4f, 4g spherically rounded and is made of one of the materials already listed above, namely natural or synthetic ruby or sapphire or a technical ceramic.

In order to keep the tip 4 in the desired position, systems similar to those used for ball-tip pens may be used, for example, as shown in FIG. 1, using a core 5 which is inserted inside the cavity 3 and may or may not be provided with a locating spring 6 and kept in position by a cap 7 mounted on the end of the stem 2 opposite to that housing the tip 4.

Other types of systems for fixing the tip may be used without affecting at all the results which can be obtained with the pen according to the invention and which depend essentially on the type of material used for manufacture of its tip.

A final note: in the example illustrated, both the ends 4f, 4g of the tip 4 are spherically rounded; depending on the design requirements, the tip 4 may also have a single rounded end, such as 4f intended to project from the abovementioned cavity 3, or may have a spherical shape (these two cases are not shown in the drawings).

1. Pen (1) suitable for writing and/or typing on screens and/or keyboards of electronic equipment such as computers, personal organizers, palmtops, telephones or the like, comprising an elongated stem (2) provided at at least one end (2e) with a coaxial cavity (3) able to house and retain inside it a rounded tip (4), characterized in that this tip (4) is made of a material chosen from a group comprising synthetic or natural hard stones and ceramic materials.

2. Pen according to claim 1, in which the said tip (4) is made of monocrystalline synthetic ruby.

3. Pen according to claim 1, in which the said tip is made of monocrystalline synthetic sapphire.

4. Pen according to claim 1, in which the said tip (4) is made of ceramic material.

5. Pen according to claim 1, in which the said elongated stem (2) terminates at one end in a portion in which a cylindrical seat (3) is formed, said seat being tapered outwards and able to house inside it the said tip (4) which is also shaped as a cylinder and at least the end (4f) of which projecting from the said cavity is spherically rounded.

6. Pen according to claim 1, in which the said tip has the shape of a sphere and is housed inside a cylindrical cavity which is tapered outwards and able to retain said tip inside it and is coaxially formed in one end of the said stem.
